(19) United States
(12) Patent Application Publication
(10) Pub. No.: US 2007/0162699 A1
(43) Pub. Date: Jul. 12, 2007

(54) Apparatus for expanding storage capacity of memory card and operating method of memory card with the same

(75) Inventors: Keon-Han Sohn, Yongin-si (KR); Sang-Bum Kim, Suwon-si (KR); Sang-Wook Kang, Seoul (KR); Soon-Sung Kwon, Yongin-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/647,428

(22) Filed: Dec. 29, 2006

(30) Foreign Application Priority Data
Jan. 6, 2006 (KR) 10-2006-0001903

(51) Int. Cl. G06F 12/00; G06F 9/00

(52) U.S. Cl. 711/115; 713/2

(57) ABSTRACT

A card controller which may include a central processing unit; a booting memory for storing a plurality of command sets; a memory discriminator for extracting memory information from an added memory to transfer the extracted memory information to the central processing unit; and a memory controller configured to be set with the command set read from the booting memory based on a control of the central processing unit, so as to access the added memory may be provided.

### PRIORITY STATEMENT

This application claims the benefit of priority to Korean Patent Application 10-2006-0001903 filed on Jan. 6, 2006, the entire contents of which is incorporated herein in its entirety by reference.

### BACKGROUND

1. Field

Example embodiments relate to a memory card and, more particularly, a memory card which may expand the storage capacity.

2. Description of Related Art

Conventional memory cards may include a storage device (hereinafter, referred to as “memory”) and a card controller for controlling the memory. In accordance with requests of a host, the card controller may supply data stored in the memory to the host or may store data transferred from the host in the memory. The memory may be mainly comprised of a flash memory. For this reason, the conventional memory card may be called a flash card. Conventional memory cards may comprise Multi Media Card (MMC), Secure Digital (SD) card, Compact Flash card, Memory Stick, and so on. Such conventional memory cards may differ in speed, size, and secure level. Since the conventional memory cards may have a small size and may store data over several hundred Mega bytes, conventional memory cards may have been applied to portable electronic products, necessitating a mass storage capacity, for example, digital cameras, camcorders, various types of game machines, and so on.

FIG. 1 is a block diagram showing a conventional card system 100.

Referring to FIG. 1, a conventional card system 100 may comprise a host 110 and a memory card 120 configured to be connected to the host 110. The memory card 120 may have a memory 140 and a card controller 130 for executing commands from the host 110. The card controller 130 may perform read, write and erase operations of the memory 140 as a result of command execution.

The card controller 130 may have a host interface 131, a booting memory 133, a buffer memory 135, a central processing unit 137, and a memory controller 139. Once connected with the host 110, the central processing unit 137 may perform a booting operation based on a booting code that may be stored in the booting memory 133. If the booting operation may be completed, the memory controller 139 may be set such that the central processing unit 137 may access the memory 140. This may cause data from the host 110 to be stored in the memory 140 or data in the memory 140 to be transferred to the host 110, under the control of the central processing unit 137. For example, when a write operation may be required, data from the host 110 may be stored in the buffer memory 135 via the host interface 131, and the central processing unit 137 may store data of the buffer memory 135 in the memory 140 via the memory controller 137, based on an instruction of the host 110. In a case where a read operation may be required, the central processing unit 137 may transfer data in the memory 140 to the host 110, based on an instruction of the host 110.

Conventionally, since the card controller 130 and the memory 140 may be molded together during a fabrication procedure of the memory card 120, the storage capacity of the memory card 120 may be fixed to that of the molded memory. For this reason, in the case of conventional memory cards described above, it may be impossible to expand their storage capacities. For example, it may be impossible to store mass data over the storage capacity of a molded memory in a conventional memory card.

### SUMMARY

Example embodiments may be directed to a card controller which may include a central processing unit; a booting memory for storing a plurality of command sets; a memory discriminator for extracting memory information from an added memory to transfer the extracted memory information to the central processing unit; and a memory controller configured to be set with a command set read from the booting memory based on a control of the central processing unit, so as to access the added memory.

Example embodiments may be directed to a memory card which may comprise a first memory; a socket configured to receive a second memory; and a card controller configured to perform a request of a host using the first and second memories.

Example embodiments may be directed to an operating method of a memory card which may comprise receiving a booting code; setting a command set for accessing a first memory according to the booting code; and judging whether a second memory may be inserted.

Example embodiments may be directed to a memory card which may comprise a socket configured such that a first memory may be inserted; and a memory controller configured to extract memory information from the first memory and to be set with a first command set according to the extracted memory information, so as to access the first memory.

Example embodiments may be directed to an operating method of a memory card which may include a first memory and a memory controller. The operating method may comprise: after performing a booting operation, setting the memory controller with a first command set so as to access the first memory; judging whether a second memory may be inserted in a socket; and when the second memory may be inserted in the socket, re-setting the memory controller with a second command set according to identification information of the second memory.

### BRIEF DESCRIPTION OF THE DRAWINGS

FIG. 1 is a block diagram illustrating a conventional card system.

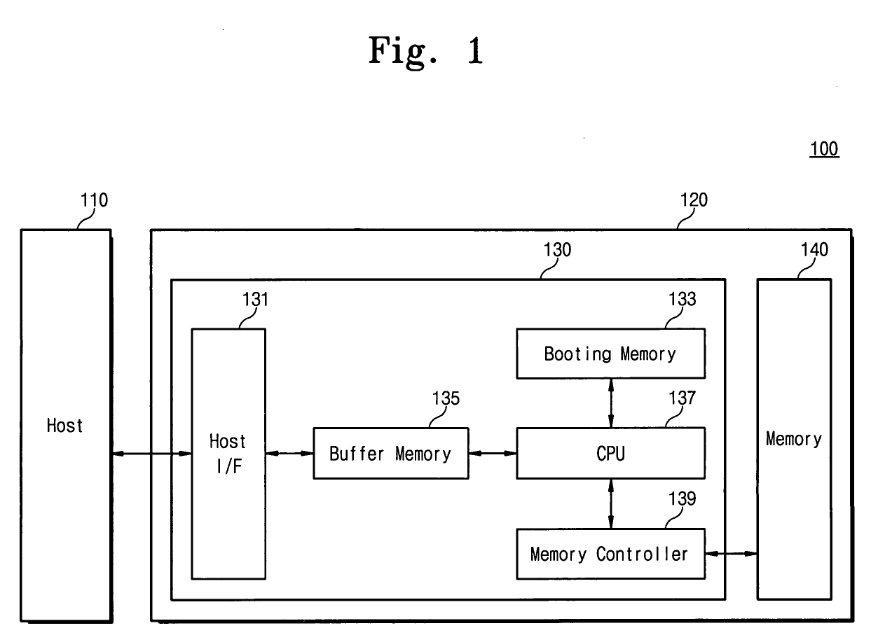

FIG. 2 is a block diagram illustrating a card system according to example embodiments.

FIG. 3 is a flowchart for describing an operation of a card system illustrated in FIG. 2.

### DETAILED DESCRIPTION OF EXAMPLE EMBODIMENTS

Example embodiments will now be described more fully hereinafter with reference to the accompanying drawings Embodiments may, however, be embodied in many different forms and should not be construed as limited to the example embodiments set forth herein. Rather, these example embodiments are provided so that this disclosure will be thorough and complete, and will fully convey the scope to those skilled in the art. It will be understood that when a component is referred to as being “on,” “connected to” or “coupled to” another component, it can be directly on, connected to or coupled to the other component or intervening components may be present. In contrast, when a component is referred to as being “directly on,” “directly connected to” or “directly coupled to” another component, there are no intervening components present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the example embodiments.

Spatially relative terms, such as “beneath,” “below,” “lower,” “above,” “upper” and the like, may be used herein for ease of description to describe one component or feature's relationship to another component(s) or feature(s) as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, and/or components.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Reference will now be made to example embodiments, which are illustrated in the accompanying drawings, wherein like reference numerals refer to the like components throughout.

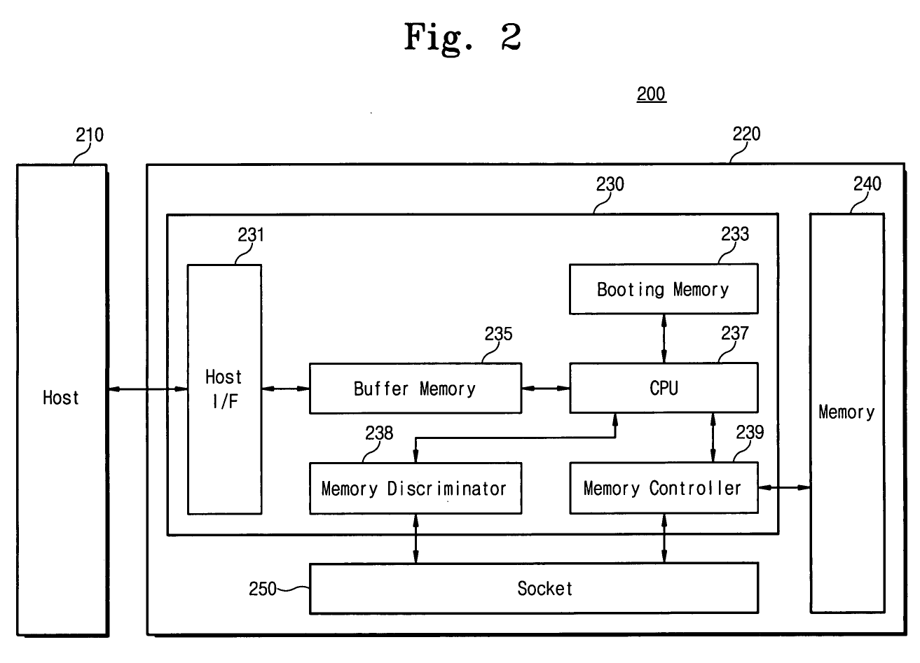

FIG. 2 is a block diagram showing a card system 200 according to an example embodiment.

Referring to FIG. 2, the card system 200 may include a host 210 and a memory card 220 that may be configured to be connected to the host 210.

The host 210 may include portable electronic devices such as digital cameras, digital camcorders, MP3 players, Personal Digital Assistant (PDA), and the like. The memory card 220 may comprise MMC, SD card, Memory stick, Compact Flash card, Smart media card, and the like.

The memory card 220 may include a card controller 230, a memory 240 that may be a molded memory, and at least one socket 250. The card controller 230 may be configured to execute instructions from the host 210. The socket 250 may be a space where a memory may be further inserted according to a need of a user. Hereinafter, the molded memory 240 may be referred to as “a first memory”, and a memory inserted in the socket 250 may be referred to as “a second memory”.

Each of the first and second memories may be formed of a non-volatile memory such as EEPROM, NOR flash memory, NAND flash memory, PRAM, MRAM, FRAM, or the like. The first memory 240 may be molded together with the card controller 230 during a fabrication procedure of the memory card 220. The second memory inserted in the socket 250 may have a storage capacity more than that of the first memory 240. For example, the first memory 240 may have a storage capacity of 256 M bytes, and the second memory may have a storage capacity of 8G bytes.

The card controller 230 may comprise a host interface 231, a booting memory 233, a buffer memory 235, a central processing unit 237, a memory discriminator 238, and a memory controller 239.

The booting memory 233 may be configured to store a booting code and instruction sets for communication between the central processing unit 237 and the first and/or second memory. The boosting code may be a command sequence for performing a booting operation and may be changed according to types and capacities of the molded memory, for example, the first memory 240. The boosting memory 233, for example, may be realized with a read only memory (ROM) as a non-volatile memory. The central processing unit 237 may read a command set from the booting memory 233 based on the booting code during booting and may set the memory controller 239 with the read command set. After the memory controller 239 may be set with the read command set, an access operation for a memory (e.g., the first memory and/or the second memory) may be carried out under the control of the central processing unit or direct memory access (DMA) (not shown) in the memory controller 239.

When connected with the host 210, the central processing unit 237 may perform a booting operation based on the booting code in the booting memory 233. The booting code may include information of the first memory 240 (such as memory information or identification information of memory type and capacity). The central processing unit 237 may read out a command set corresponding to the first memory 240 from the booting memory 233 based on the booting code, and the memory controller 239 may be set with the read command set. For example, if the booting operation may be completed, the memory controller 239 may be set such that the central processing unit 237 or the DMA in the memory controller 239 accesses the first memory 240. Under the control of the central processing unit 237, data from the host 210 may be stored in the first memory 240 or data in the first memory 240 may be transferred to the host 210. For example, data from the host 210 may be stored in the buffer memory 235 via the host interface 231, and the central processing unit 237 or the DMA in the memory controller 239 may store data from the buffer memory 235 in the first memory 240 according to an instruction (for example, a write instruction) of the host 210. The central processing unit 237 or the DMA in the memory controller 239 may transfer data in the first memory 240 to the host 210 based on an instruction (for example, a read instruction) of the host 210. The buffer memory 235 may be comprised of SRAM.

The memory discriminator 238 may judge whether the second memory may be inserted in the socket 250, and may output a judgment result to the central processing unit 237. For example, if the second memory may be inserted in the socket 250 before or after booting, the memory discriminator 238 may extract information (for example, identification or memory information of memory type and capacity) from the second memory and may send the information to the central processing unit 237. The memory discriminator 238 may judge whether the second memory may be inserted in the socket 250, based on various manners. For example, the memory discriminator 238 may be configured to check the socket 250 every given time or at predetermined times. Further, the memory discriminator 238 may be configured to check the socket 250 using an interrupt manner. The central processing unit 237 may read a corresponding command set from the booting memory 233 based on identification/memory information of the second memory from the memory discriminator 238. The memory controller 239 may be again set with the command set for accessing the second memory that may be supplied from the central processing unit 237. Accordingly, it may be possible to access the first memory 240 and the second memory using one memory controller 239 according to requests of the host 210. This may mean that the storage capacity of the present memory card 220 may be expanded by that of the second memory that may be inserted in the socket 250.

As understood from the above description, it may be possible to solve the problem of expanding the storage capacity of a memory card with a molded memory. Accordingly, it may be possible to satisfy increasing needs of a large-capacity memory card for real image support of the host 210.

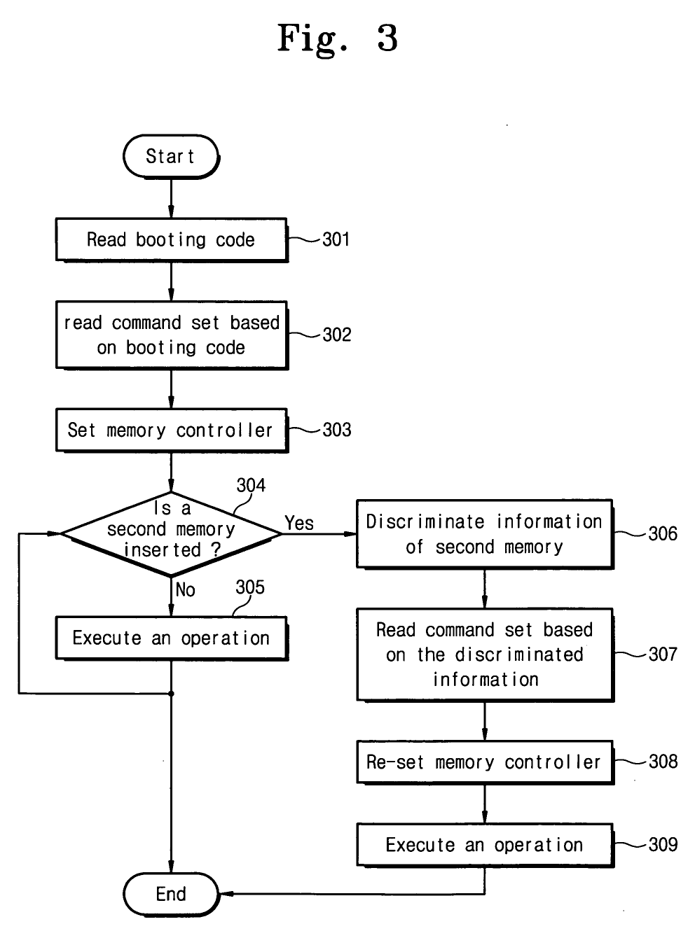

FIG. 3 is a flowchart for describing an operation of a card system illustrated in FIG. 2.

Referring to FIG. 3, in block 301, when the memory card 220 may be connected to the host 210, the central processing unit 237 may read out a booting code from the booting memory 233. Alternatively, a booting code may be provided to the central processing unit 237 from the booting memory 233 at power-up.

In block 302, the central processing unit 237 may read from the booting memory 233 a command set for accessing the first memory 240 based on the booting code. In block 303, the memory controller 239 may be set with the command set read by the central processing unit 237.

In block 304, the memory discriminator 238 may judge whether a second memory may be inserted in the socket 250. If a second memory may not be inserted, in block 305, the central processing unit 239 may perform an operation that may be requested by the host 210.

If a second memory may be inserted, in block 306, the memory discriminator 238 may read memory information (e.g., memory type and capacity) from the second memory that may be inserted in the socket 250. In block 307, the central processing unit 237 may read a corresponding command set from the booting memory 233 based on the read memory information from the second memory. In block 308, the memory controller 239 may be again set with the command set read out in block 307 in addition to the command set established in block 303 so as to access both the first memory 240 and the second memory.

As the memory controller 239 may be set with the command sets for accessing the first memory 240 and the second memory, in block 309, the central processing unit 237 may access the first memory 240 and/or the second memory. If the requested operation may be completed, the procedure may be ended.

According to example embodiments, a discriminating operation of the memory discriminator 238 may be performed after setting of the command set to the first memory 240. However, a discriminating operation of the memory discriminator 238 may not be limited thereto. For example, before the memory card 220 may be electrically connected to the host 210, the second memory may be inserted in the socket 250. For example, the memory controller 239 may be set with command sets based on a predetermined priority. If an operation of setting a command set of the first memory 240 may be prior to that of the second memory, the memory controller 239 may first be set with the command set of the first memory 240 and then with the command of the second memory.

The present memory card may be variously changed. For example, the memory card 220 may be realized so as to include only the card controller 230 and the socket 250 without the first memory 240. In this case, the memory controller 239 may be set with a command set based on memory information that may be read out from a memory inserted in the socket 250.

According to example embodiments, including the memory card 220, the card controller 230 may be realized so as to include constituent elements 231, 233, 235, 237, 238 and 239 illustrated in FIG. 2. Alternatively, the card controller 230 may be realized so as to include constituent elements 231, 233, 235, 237, 238 and 239 together with the socket 250. A booting code and command sets stored in the booting memory 233 may be stored in the first memory 240. For example, the booting code and command sets may be provided to the central processing unit 237 from the first memory 240.

Although example embodiments have been shown and described in this specification and figures, it would be appreciated by those skilled in the art that changes may be made to the illustrated and/or described example embodiments without departing from their principles and spirit, the scope of which is defined by the claims and their equivalents.

What is claimed is:

1. A card controller comprising:
a central processing unit;
a booting memory for storing a plurality of command sets;
a memory discriminator for extracting memory information from an added memory to transfer the extracted memory information to the central processing unit; and
a memory controller configured to be set with a command set read from the booting memory based on a control of the central processing unit, so as to access the added memory.

2. The card controller of claim 1, wherein the booting memory stores a booting code and the central processing unit performs a booting operation according to the booting code.

3. The card controller of claim 1, wherein the added memory is electrically connected to the memory controller and the memory discriminator via a socket.

4. The card controller of claim 2, wherein the memory controller comprises a direct memory access.

5. The card controller of claim 4, further comprising:
a host interface configured to interface with a host; and
a buffer memory for temporarily storing data to be input/output via the host interface.

6. A memory card comprising:
a first memory;
a socket configured to receive a second memory; and
a card controller configured to perform a request of a host using the first and second memories.

7. The memory card of claim 6, wherein the card controller includes
a central processing unit;
a booting memory for storing a plurality of command sets;
a memory controller configured to be set with a first command set read from the booting memory based on a control of the central processing unit, so as to access the first memory; and
a memory discriminator configured to discriminate whether the second memory is inserted in the socket.

8. The memory card of claim 7, wherein when the second memory is inserted in the socket, the memory discriminator extracts memory information from the second memory and sends the extracted memory information to the central processing unit; and the memory controller is again set with a second command set read from the booting memory based on the control of the central processing unit so as to access the first and second memories.

9. The memory card of claim 8, wherein the booting memory stores a booting code and the central processing unit performs a booting operation based on the booting code.

10. The memory card of claim 7, wherein the memory discriminator is configured to judge the inserting of the second memory in the socket using an interrupt manner.

11. The memory card of claim 7, wherein the memory controller comprises a direct memory access.

12. The memory card of claim 11, wherein the card controller further includes
a host interface configured to interface with a host; and
a buffer memory for temporarily storing data to be input/output via the host interface.

13. The memory card of claim 6, wherein the second memory has a storage capacity more than that of the first memory.

14. The memory card of claim 6, wherein the first memory is molded with the card controller.

15. The memory card of claim 12, wherein the buffer memory is SRAM, and the each of the booting memory, the first memory, and the second memory is a non-volatile memory.

16. The memory card of claim 15, wherein the booting memory is ROM and each of the first and second memories is one selected from a group of EEPROM, NOR flash memory, NAND flash memory, PRAM, MRAM, and FRAM.

17. An operating method of a memory card comprising:
receiving a booting code;
setting a command set for accessing a first memory according to the booting code; and
judging whether a second memory is inserted.

18. The operating method of claim 17, further comprising:
when the second memory is inserted, judging information of the second memory.

19. The operating method of claim 18, further comprising:
re-setting the command set so as to access both the first memory and the second memory according to the judged information of the second memory.

20. A memory card comprising:
a socket configured such that a first memory is inserted; and
a memory controller configured to extract memory information from the first memory and to be set with a first command set according to the extracted memory information, so as to access the first memory.

21. The memory card of claim 20, further comprising a card controller that includes
a central processing unit;
a booting memory for storing the first command set;
a memory discriminator configured to extract the memory information from the first memory inserted in the socket and transfer the extracted memory information to the central processing unit; and wherein
the memory controller is configured to be set with the first command set read from the booting memory based on a control of the central processing unit, so as to access the first memory.

22. The memory card of claim 21, wherein when a second memory different from the first memory is inserted in the socket, the memory discriminator extracts memory information from the second memory and sends the extracted memory information to the central processing unit; and the memory controller is again set with a second command set read from the booting memory based on the control of the central processing unit so as to access the second memory.

23. The memory card of claim 21, further comprising:
a second memory molded with the card controller.

24. The memory card of claim 21, wherein the booting memory stores a booting code and the central processing unit performs a booting operation according to the booting code.

25. The memory card of claim 20, wherein the memory controller judges whether the first memory is inserted in the socket, based on an interrupt manner.

26. The memory card of claim 20, wherein the memory controller judges whether the first memory is inserted in the socket, at predetermined times.

27. An operating method of a memory card which comprises a first memory and a memory controller, the operating method comprising:
after performing a booting operation, setting the memory controller with a first command set so as to access the first memory;
judging whether a second memory is inserted in a socket; and
when the second memory is inserted in the socket, re-setting the memory controller with a second command set according to identification information of the second memory.

28. The operating method of claim 27, wherein whether the second memory is inserted in the socket is judged in an interrupt manner.
